(19) United States
(12) Patent Application Publication
(10) Pub. No.: US 2023/0385663 A1
(43) Pub. Date: Nov. 30, 2023

(54) LARGE SCALE FORECASTING WITH EXPLANATION INFORMATION FOR TIME SERIES DATASETS

(71) Applicant: Oracle International Corporation, Redwood Shores, CA (US)

(72) Inventors: Chirag Ahuja, Delhi (IN); Vikas Rakesh Upadhyay, Seattle, WA (US); Samik Raychaudhuri, Bangalore (IN); Syed Fahad Allam Shah, Washougal, WA (US); Hariharan Balasubramanian, Redmond, WA (US)

(73) Assignee: Oracle International Corporation, Redwood Shores, CA (US)

(21) Appl. No.: 18/323,339

(22) Filed: May 24, 2023

Related U.S. Application Data
(60) Provisional application No. 63/347,368, filed on May 31, 2022.

(51) Int. Cl. G06N 5/045

(52) U.S. Cl. CPC G06N 5/045

(57) ABSTRACT

A time series forecasting system is disclosed that obtains a time series forecast request requesting a forecast for a particular time point. The forecast request identifies a primary time series dataset for generating the requested forecast and a set of features related to the primary time series dataset. The system provides the primary time series dataset and the set of features to a model to be used for generating the forecast. The model computes a feature importance score for one or more features and selects a subset of features based on their feature importance scores. The model determines attention scores for a set of data points in the primary time series dataset based on the selected subset of features. The system predicts an actual forecast for the particular time point based on the attention scores and outputs the actual forecast and explanation information associated with the actual forecast.

### CROSS-REFERENCES TO RELATED APPLICATIONS

The present application is a non-provisional application of and claims the benefit and priority under 35 U.S.C. 119(e) of U.S. Provisional Application No. 63/347,368, filed May 31, 2022, entitled “Large Scale Forecasting with Inherent Explainability for Multiple Time Series Datasets,” the entire contents of which are incorporated herein by reference for all purposes.

### BACKGROUND

A time series or time series dataset is a sequence of data points, measured typically at successive times over a time interval. Examples of time series data include: a set of temperature values captured every day over several days, the price of a stock observed every 5 minutes, monthly sales for a corporation captured over several months, and the like. Time series forecasting refers to a set of forecasting techniques that, given a time series, uses one or more models to forecast an event or observation for a time point in the future. Time series forecasting is used in various fields such as for making economic forecasts, stock market forecasts, product sales forecasts, and so on. The models used for analyzing time series data and for making forecasts may include, for instance, machine learning models, statistical models and the like. Typically, when a model (e.g., a machine learning model or a statistical model) is used for time series forecasting, an appropriate model has to be first selected based upon the time series data to be used for the forecasting. The model then has to be trained and validated using the time series data, and after the model has reached an acceptable level of accuracy, the model is then used for forecasting for a future time point.

Statistical models have been generally used for forecasting individual time series datasets. These models can predict the future of an individual time series dataset by considering historical data pertaining to the time series dataset. However, in certain situations, it is beneficial to analyze a set of related time series datasets that can be grouped together. For instance, an entity such as a retail store may want to predict the sales of different products sold by the store. The sales of each product represent an individual time series dataset comprising daily sales (e.g., number of units) of the product sold by the entity, recorded in time order. In this situation, training individual time series models for each time series dataset is a time consuming task and not a scalable solution.

Certain machine learning models have been used to analyze related time series datasets. These models are trained and validated using a set of related time series datasets and then used for generating forecasts for new time series datasets that are similar to the related time series datasets that it has been trained on. While these models can potentially capture more patterns and can be trained on multiple related time series datasets, they are more complex to work with for data scientists than statistical models. For instance, in certain situations, these models sometimes need to analyze a large number (e.g., five to ten million) of related time series datasets simultaneously. For instance, to analyze the sale of products by an entity, building a forecast model for millions of products is not a scalable solution using limited computing resources. Even if cloud solutions are used, building such a model for a large number of products is not feasible. There is thus a need for making the techniques related to predicting forecasts for multiple time series datasets more efficient and accurate than is possible in existing implementations.

### BRIEF SUMMARY

The present disclosure relates generally to generating a forecast for a multiple time series dataset, where the multiple time series dataset comprises a set of individual related time series datasets. More specifically, but not by way of limitation, this disclosure describes a time series forecasting system that is capable of analyzing large scale datasets (comprising thousands or even millions of time series datasets) for an entity. Instead of creating multiple models to generate a requested forecast for a particular future time point (T) for each time series dataset in a multiple time series dataset, the disclosed system includes capabilities to generate and train a single model that can be applied across a large number of related time series datasets of different sizes. In addition to a primary (target) time series dataset that is to be forecasted, the disclosed system takes into consideration a set of features associated with the primary time series dataset to generate a requested forecast for the primary time series dataset.

In certain embodiments, a time series forecasting system is disclosed that obtains a time series forecast request requesting a forecast for a particular time point. The time series forecast request identifies a primary time series dataset to be used as a basis for generating the requested forecast and a set of features related to the primary time series dataset. The system provides the primary time series dataset and the set of features to a model to be used for generating the forecast. The model is trained upon or fit to the time series data points in the primary time series dataset and the set of features related to the primary time series dataset. The model computes a feature importance score for one or more features and selects a subset of features based on their feature importance scores. Based on the selected subset of features, the model then determines attention scores for a set of data points in the primary time series dataset. The system then predicts an actual forecast for the particular time point based on the attention scores and outputs the actual forecast and explanation information associated with the actual forecast to a requesting user.

In certain examples, the set of set of features related to the primary time series dataset include dynamic features related to the primary time series dataset and a static metadata features related to the primary time series dataset. In certain examples, a dynamic feature may be represented as an additional feature time series dataset related to the primary time series dataset. Each data point in a set of data points represented by the additional feature time series dataset comprises a value of a dynamic feature and an associated time value.

In certain examples, the datapoints in the set of datapoints represented by the additional feature time series dataset represent past covariate values of the dynamic feature related to the primary time series dataset. In certain examples, the datapoints in the set of datapoints represented by the additional feature time series dataset represent a combination of past covariate values and future covariate values of the dynamic feature related to the primary time series dataset.

In certain examples, the primary time series dataset is an individual time series dataset comprised in a multiple time series dataset. The multiple time series dataset is composed of a set of individual time series datasets. In certain examples, an individual time series data set in the set of individual time series datasets represents a univariate time series dataset. In other examples, an individual time series data set in the set of individual time series datasets represents a multivariate time series dataset.

In certain examples, the system determines attention scores for a set of data points in the primary time series dataset by generating an encoded representation of the primary time series dataset and generating an encoded representation of a feature time series dataset associated with a feature in the selected subset of features. The model then determines information identifying correlations between one or more data points of the encoded representation of the primary time series dataset and one or more data points of the feature time series dataset associated with the feature in the selected subset of features. Based on the determined correlations, the model then determines the attention scores of the set of data points in the primary time series dataset.

In certain examples, the explanation information associated with the actual forecast comprises information identifying the plurality of attention scores determined for the plurality of data points in the primary time series dataset. In other examples, the explanation information associated with the actual forecast comprises information identifying the feature importance scores computed for one or more features in the set of features related to the primary time series dataset.

### BRIEF DESCRIPTION OF THE DRAWINGS

Features, embodiments, and advantages of the present disclosure are better understood when the following Detailed Description is read with reference to the accompanying drawings.

FIG. 1 depicts a computing environment that includes a time series forecasting system that includes capabilities for predicting a forecast for a time series dataset and generating explanation information for the predicted forecast, according to certain embodiments.

FIG. 2 depicts additional details of the processing performed by the feature selection subsystem in the time series forecasting system shown in FIG. 1, according to certain embodiments.

FIG. 3 depicts additional details of the processing performed by the feature attention score computation subsystem within the time series forecasting system 108 shown in FIG. 1, according to certain embodiments.

FIG. 4 depicts an example of a process by which the time series forecasting system 108 shown in FIG. 1 generates a forecast for a time series dataset, according to certain embodiments.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates generally to generating a forecast for a multiple time series dataset, where the multiple time series dataset is composed of a set of individual related time series datasets. More specifically, but not by way of limitation, this disclosure describes a time series forecasting system that is capable of analyzing large scale datasets (comprising thousands or even millions of time series datasets) for an entity. Instead of creating multiple models to generate a requested forecast for a particular future time point (T) for each time series dataset in a multiple time series dataset, the disclosed system includes capabilities to generate and train a single model that can be applied across a large number of related time series datasets of different sizes. In addition to a primary (target) time series dataset that is to be forecasted, the disclosed system takes into consideration a set of features associated with the primary time series dataset to generate a requested forecast for the primary time series dataset. The set of features may include dynamic features and static features related to the primary time series dataset. A dynamic feature may represent a characteristic (external information) related to the primary time series dataset that can change over time and that can impact the prediction of the forecast values for the primary time series dataset. A static feature (also referred to herein as a static metadata feature) may represent a feature that remains constant over time. A static feature can also potentially impact the predicted forecast and can provide valuable context for items in a primary time series dataset.

The disclosed system includes capabilities to utilize a combination of static features as well as dynamic features related to the primary time series dataset described above to improve the accuracy of the prediction by a model to forecast values for the primary time series dataset. Existing forecasting models include capabilities to perform predictions on a primary (target) time series dataset by taking into consideration either only certain types of dynamic features or only certain types of static features in order to make a prediction. The prediction by the disclosed model can additionally be seamlessly extended to a multiple time series dataset by providing the model with a set of individual related time series datasets that are part of a multiple time series dataset. The model includes capabilities to analyze each individual (target) time series dataset in combination with the static features and dynamic features related to each individual time series dataset to generate a prediction for each individual time series dataset in the multiple time series dataset. Once the model has been trained and validated using the set of related individual time series datasets that are part of the multiple time series dataset, it can be used for generating forecasts for new time series datasets that are similar to the related time series datasets that it has been trained on.

The disclosed system includes capabilities for generating a forecast for a univariate time series dataset as well as a multivariate time series dataset. A univariate time series dataset refers to a time series dataset that consists of a single observation that is recorded sequentially over equal time increments. A multivariate time series dataset refers to a time series dataset that consists of multiple observations recorded sequentially over equal time increments. Thus, the set of individual related time series datasets that are part of a multiple time series dataset provided to the model may be composed of univariate time series datasets or multivariate time series datasets. The model is configured to analyze the individual “univariate” or “multivariate” time series datasets in combination with the static and dynamic features related to the individual time series datasets to generate a prediction for each individual time series dataset in the multiple time series dataset.

In certain examples, the model used by the disclosed system includes capabilities to compute feature importance scores for features (e.g., dynamic features and static features) associated with the primary time series dataset. A feature importance score is a measure of how useful a particular feature (dynamic feature and/or static feature) is at predicting a forecast value for a target variable (i.e., primary feature) of the primary time series dataset. A high feature importance score generally implies that a specific feature will have a larger effect on the model that is being used to predict the forecast value for the target variable. Based on the feature importance scores, the model then selects a subset of the features to be used to predict the forecast result for the primary time series dataset. In certain examples, the model implemented by the system is a machine learning model, such as a neural network.

Using the selected features, the model then determines, for each selected feature, the correlations between the data points of a time series dataset corresponding to a selected feature and the data points of the primary time series dataset. Based on the determined correlations, the model then identifies the relevant input time steps (i.e., relevant data points) of the primary time series dataset that are most relevant for making a prediction. The model assigns attention scores (also referred to herein as attention weights) to the relevant input time steps of the primary time series dataset. The more relevant data points are assigned higher attention weights. By assigning different attention scores to certain data points of the input sequence of a primary time series dataset, the model is able to identify the relevant data points to be used for prediction of the primary dataset thereby improving the accuracy of the prediction.

The model then predicts an actual forecast that includes a forecast result (forecast value) predicted for a future time point for the primary time series dataset. In certain embodiments, for a forecast result predicted by the model, the system provides an explanation for the forecast, where the explanation for the forecast includes information identifying the attention scores computed for the individual time series data points in the primary time series dataset on the forecast. The attention scores represent information indicative of the importance or impact or influence of individual time series data points (i.e., past values) in the primary time series dataset on the forecast. This enables the user to have some visibility into why the particular forecast was predicted by the model and increases the user's level of confidence in the predicted value. In certain embodiments, the explanation information additionally includes the feature importance scores computed for the selected features. The forecast result along with the explanation information is provided to a requesting user.

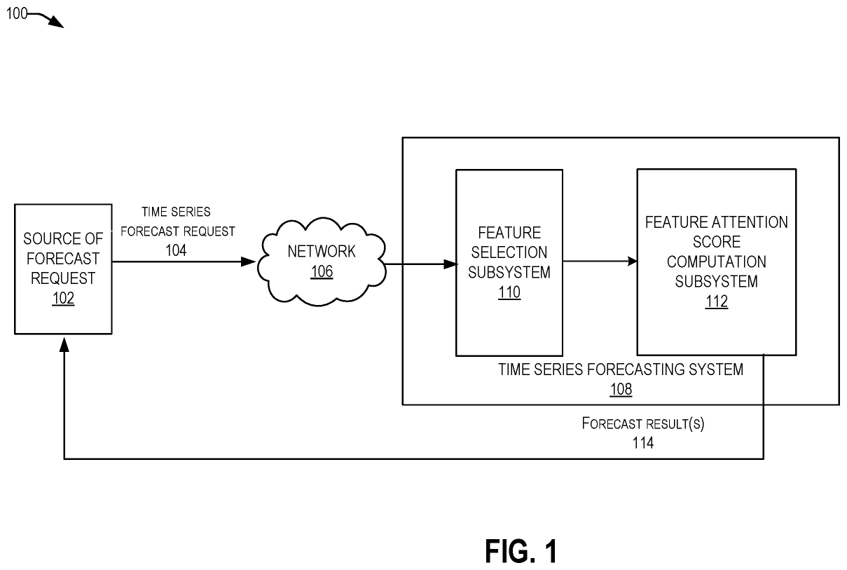

Referring now to the drawings, FIG. 1 depicts a computing environment that includes a time series forecasting system that includes capabilities for predicting a forecast for a time series dataset and generating explanation information for the predicted forecast, according to certain embodiments. The time series forecasting system 108 may be implemented by one or more computing systems that execute computer-readable instructions (e.g., code, program) to implement the time series forecasting service system. As depicted in FIG. 1, the time series forecasting system 108 includes various systems and subsystems including a feature selection subsystem 110 and a feature attention score computation subsystem 112. The systems and subsystems depicted in FIG. 1 may be implemented using software (e.g., code, instructions, program) executed by one or more processing units (e.g., processors, cores) of a computing system, hardware, or combinations thereof. The software may be stored on a non-transitory storage medium (e.g., on a memory device).

The time series forecasting system 108 may be implemented in various different configurations. In certain embodiments, the time series forecasting system 108 may be implemented on one or more servers of a cloud provider network and its forecasting services may be provided to subscribers of cloud services on a subscription basis. Computing environment 100 depicted in FIG. 1 is merely an example and is not intended to unduly limit the scope of claimed embodiments. One of ordinary skill in the art would recognize many possible variations, alternatives, and modifications. For example, in some implementations, the time series forecasting system 108 can be implemented using more or fewer subsystems than those shown in FIG. 1, may combine two or more subsystems, or may have a different configuration or arrangement of subsystems.

In certain embodiments, the time series forecasting system 108 provides a fast and reliable service for predicting a forecast for a time series dataset and generating explanation information associated with the predicted forecast. The system is capable of capable of analyzing large and long term time series datasets (comprising thousands or even millions of time series datasets) of different sizes by generating and training a single model that can be applied across different related time series datasets of different sizes. The explanation information provides information regarding the relative importance or impact of one or more features (e.g., dynamic features and static features) related to the primary time series dataset on the actual forecast (forecast result) predicted for the primary time series dataset. The actual forecast along with explanation information may then be output by the time series forecasting system to a requesting user.

As depicted in FIG. 1, a time series forecast request (e.g., 104) may be obtained from a source 102 that is communicatively coupled to the time series forecasting system 108 possibly via a communication network 106 (e.g., the Internet). The source 102 may represent a user device of an entity such as a customer (e.g., an organization, an enterprise, or an individual) who subscribes to the services provided by the time series forecasting system 108. The user device may be of various types, including but not limited to, a mobile phone, a tablet, a desktop computer, and the like. A user of the entity may interact with the time series forecasting system 108 using a browser executed by the user device. For example, the user may use a user interface (UI) (which may be a graphical user interface (GUI)) of the browser executed by the user device to interact with the time series forecasting system. In other examples, the source 102 may also represent an external service that generates a forecast request for an entity such as a customer (e.g., an organization, an enterprise, or an individual) who subscribes to the services provided by the time series forecasting system.

In certain examples, the time series forecast request 104 identifies a primary (or target) time series dataset and a forecast horizon identifying a time point (or a set of time points) for which a forecast is requested. The primary time series dataset includes historical data points based upon which the forecast is to be made. The data points are recorded in time order and each data point in the time series dataset comprises a value (e.g., an observed value) and an associated time. In certain examples, the time series forecast request 104 may be associated with a set of features. The set of features represent external information related to the primary time series dataset that can impact the forecast values (i.e., forecast result) predicted for the primary time series dataset and improve the accuracy of prediction of the forecast values for the primary time series dataset.

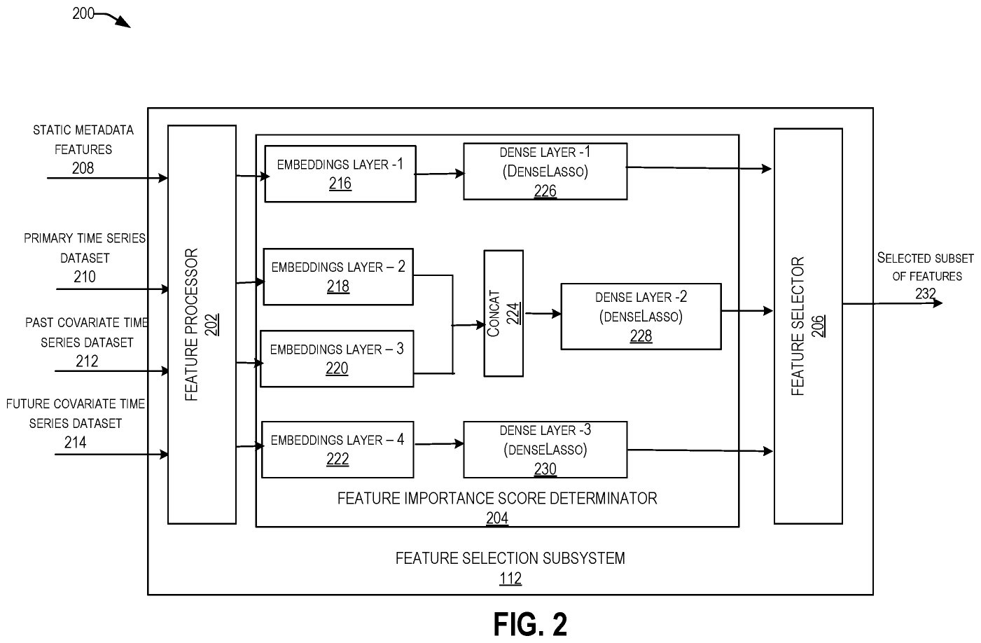

In certain examples, the set of features may include dynamic features and static features related to the primary time series dataset. A dynamic feature may represent a characteristic (external information) related to the primary time series dataset that can change over time and that can impact the prediction of the forecast values for the primary time series dataset. A static feature (also referred to herein as a static metadata feature) may represent a feature that remains constant over time. A static feature can also potentially impact the predicted forecast and can provide valuable context for items in a primary time series dataset. Additional information regarding the various types and representation of dynamic features and static features that may be provided as part of the forecast request 104 are described in FIG. 2.

The primary time series dataset that is received as part of the forecast request 104 may represent a univariate time series dataset or a multivariate time series dataset. A univariate time series dataset refers to a time series dataset that consists of a single observation that is recorded sequentially over equal time increments. Examples of a univariate time series dataset include monthly/daily number of sales of a product over a period of time, the minimum daily temperatures observed over a period of time and so on. A multivariate time series dataset refers to a time series dataset that consists of multiple observations recorded sequentially over equal time increments. Each observation at a time point pertains to multiple dependent variables and each observation is represented as a vector of values instead of a single value. Typically for a multivariate time series, since the variables in the vector are closely interrelated, they may be considered to be single observations in vector form instead of distinct observations from separate time series datasets. An example of a multivariate time series dataset may include tracking a patient's daily weight, daily body temperature, daily blood pressure, daily cholesterol levels etc., where the vector of health variables monitored for each patient during a period of time (e.g., a day) forms a multivariate time series dataset.

In certain examples, and as described above, the time series forecast request 104 comprises a single primary time series dataset and a set of features associated with the primary time series dataset. In alternate embodiments, the time series forecast request 104 may comprise a multiple time series dataset. A multiple time series dataset may be composed of a set of individual related time series datasets. Each individual time series dataset (a primary/target time series dataset) comprises a sequence of data points recorded in time order. Each data point in a primary time series dataset comprises a value (i.e., a lagged observed value) of a primary feature (also referred to herein as a primary variable) to be forecasted and an associated time value that is less than the forecast time point T. A multiple time series dataset can be composed of a set of individual “univariate” time series datasets or a set of individual “multivariate” time series datasets.

For instance, a first primary time series dataset in a multiple univariate time series dataset may comprise a set of lagged historical values recorded in time order, where each lagged value represents the sales (primary feature) of a first product at a certain point in time (e.g., during a month). A second primary time series dataset in the multiple univariate time series dataset may represent sales (i.e., the number of items sold) of a different product recorded in time order over the period of time and so on. As another example, the individual univariate time series datasets in a multiple univariate time series dataset may represent daily weight values for different patient, where the daily weight values for a particular patient forms a separate univariate time series dataset in a multiple time series dataset.

Responsive to obtaining a time series forecast request 104 as described above, the time series forecasting system 108 analyzes the time series forecast request 104 and predicts an actual forecast (forecast result) for a particular data point for each individual primary time series dataset(s) that is part of the time series forecast request 104. The system 108 then presents the forecast result(s) to a user of the system. In certain examples, as will be described in detail below, a forecast result generated by the system 108 may include explanation information pertaining to the forecast result. The explanation information provides information regarding the relative importance or impact of one or more features (e.g., dynamic features and static features) related to the primary time series dataset on the actual forecast (forecast result) predicted for the primary time series dataset. The actual forecast along with the explanation information may then be output by the time series forecasting system to a user of the source 102.

In certain embodiments, and as depicted in FIG. 1, the time series forecasting system 108 comprises a feature selection subsystem 110 and a feature attention score computation subsystem 112. The feature selection subsystem 110 computes feature importance scores for features in the set of features associated with the primary time series dataset. A feature importance score is a measure of how useful a particular feature (dynamic feature and/or static feature) is at predicting a forecast value for a target variable (i.e., primary feature) of the primary time series dataset. A high feature importance score generally implies that a specific feature will have a larger effect on the model that is being used to predict the forecast value for the target variable. The feature selection subsystem 110 then selects a subset of the features based on the feature importance scores and provides the subset of features to the feature attention score computation subsystem 112 for further analysis.

The feature attention score computation system 112 is configured to analyze each selected feature from the subset of selected features and based on the analysis computes attention scores for individual time series data points in the primary time series dataset. The attention scores represent information indicative of the importance or impact or influence of individual time series data points in the primary time series dataset on the forecast. In certain examples, the attention scores may provide additional explanation information for the predicted forecast and may be presented to a requesting user along with the forecast results. Additional details of the processing performed by the subsystems 110, 112 depicted in FIG. 1 of the time series forecasting system 108 is described below with respect to FIGS. 2-4 and their accompanying description.

FIG. 2 depicts additional details of the processing performed by the feature selection subsystem 110 in the time series forecasting system 108 shown in FIG. 1, according to certain embodiments. As depicted in FIG. 2, the feature selection subsystem 110 includes various components including a feature processor 202, a feature importance score determinator 204 and a feature selector 206. The components 202, 204 and 206 depicted in FIG. 2 may be implemented using software (e.g., code, instructions, program) executed by one or more processing units (e.g., processors, cores) of a computing system, hardware, or combinations thereof. The software may be stored on a non-transitory storage medium (e.g., on a memory device).

As previously described, the time series forecasting system 108 (shown in FIG. 1) obtains a time series forecast request 104 (e.g., from a source 102). The time series forecast request 104 may include a primary time series dataset and a set of features related to the primary time series dataset. The set of features may include dynamic features that represent a characteristic (external information) related to the primary time series dataset that can change over time and/or static metadata features that remain constant over time but can provide valuable context for the items in the primary time series dataset.

In a certain implementation, a dynamic feature related to a primary time series dataset may be represented an additional feature time series dataset that is related to the primary (target) time series dataset. The additional feature time series dataset comprises time series data that is not included in the primary time series dataset. Each data point in the additional feature time series dataset comprises a value of a related feature (dynamic feature) and an associated time value. In certain examples, the data points in an additional feature time series dataset may represent past covariate values of a dynamic feature related to a primary time series dataset. These past covariate values denote observed values of a dynamic feature that are known in the past but cannot be known in the future. For instance, the price of oil or the price of a product may represent external information related to a primary time series dataset that represents the sale of a product recorded in time order. The oil price and the product price represent dynamic features that can help forecast the future sales (primary feature) of the product. This information is known in the past but cannot be known in advance because it represents information that must be measured directly to know its value. The observed historical product prices thus represent a past covariate time series dataset comprising a set of past covariate values (lagged, observed values) representing product prices over a period of time. Similarly, the observed historical oil prices may represent a past covariate time series dataset comprising a set of past covariate values (lagged, observed values) representing oil prices over a period of time.

In other examples, a dynamic feature related to the primary time series may also be represented as a future covariate time series dataset. A future covariate time series dataset comprises past covariate values as well as future covariate values that are known at prediction time for the span of the forecast horizon. The values in a future covariate time series dataset thus represent a combination of lagged known values and future known values associated with the dynamic feature. In certain examples, the length of a future covariate time series dataset is equal to the length of the provided target time series dataset plus the prediction length which includes the set of future known values of the future covariate time series dataset. Examples of dynamic features (that comprise future known values) related to a primary time series dataset that represents the sale of a product recorded in time order may include, for instance, calendar information (e.g., future holidays) or weather forecasts that are known at prediction time. Other examples, may include, for instance, information that relates to whether a store that sells the product was (or will be) open or closed at a particular data point (e.g., a particular day), whether the product was (or will be) associated with a marketing campaign (for e.g., a product promotion) on a particular day, the number of workers who were (or will be) working at the store on a particular day and so on. The values of these dynamic features are known in the past as well as the future and hence can be represented in a future covariate time series dataset.

In certain examples, a primary time series dataset that is received as part of a time series forecast request (e.g., 104) can be further enriched with additional features. For instance, an additional feature may represent a temporal feature that can be automatically added by system (or be provided by an administrator of the system) to the historical data points associated with the primary time series dataset. By way of example, a data point in a primary time series dataset that represents the sale of a product at a point in time could be enriched with an additional temporal feature such as the “day of the month.” A scalar value corresponding to the temporal feature can be added to each data point of the primary time series dataset to create an enriched primary time series dataset comprising a set of time feature vectors, e.g., [15,10] to denote a time series data point that was obtained on the 15^{th} of October.

As previously described, a time series forecast request (e.g., 104) may also be associated with a set of static metadata features. Static metadata features can have an important impact on the forecast and can provide valuable context for the items in a primary time series dataset. For instance, a static metadata feature (e.g., a store location) could have different temporal dynamics for sales (e.g., a rural store may see higher weekend traffic, but a downtown store may see daily peaks after working hours). In a certain implementation, to incorporate a static metadata feature into the prediction of a future value for the primary time series data set, each data point in a primary time series dataset can be additionally enriched with one or more static metadata features. A scalar value corresponding to the static feature can be added to each data point of the primary time series dataset to create an enriched time series dataset comprising a set of time feature vectors. For example, a static metadata feature corresponding to the “store location” can be added to each data point of the primary time series dataset to create a time feature vector [15,10, Denver] to denote a time series data point (representing sale of a product) that occurred on the 15^{th} of October at a store located in Denver.

The time series forecasting system 108 obtains the time series forecast request (104) as described above and provides the time series forecast request 104 to the feature selection subsystem 112. In the embodiment depicted in FIG. 2, the time series forecast request 104 comprises a primary time series dataset 210, a set of dynamic features (a past covariate time series dataset 212 and a future covariate time series dataset 214) associated with the primary time series dataset 206 and a set of static metadata features 208 associated with the primary time series dataset 210. The primary time series dataset 210 and the set of features (e.g., 208, 212, 214) related to the primary time series dataset 210 are initially processed by a feature processor 202 within the feature selection subsystem 110. The preprocessing performed by feature processor 202 may involve, for instance, performing log normalization of the target variables, performing standard scaling across the additional time series datasets and encoding labels for the static metadata features and the additional time series datasets. For instance, in certain examples, the static metadata features 208 and the dynamic features (212, 214) may represent discrete features (e.g., country names, holidays, store closure information and so on) associated with a primary time series dataset (e.g., 210) that represents the sale of a product at a point in time. The pre-processing that can be applied on a discrete feature such as “country names” may involve, for instance, encoding the country name into a discrete value. By way of example, a country “US” represented by a static metadata feature may be encoded into a value “10,” and a different country “UK” represented by the static metadata feature may be encoded into a different value, “12.”

In certain examples, the static features 208 may also represent a continuous feature (e.g., distance from a competitor store) comprising continuous numeric values. Additionally, the primary time series dataset 210 may represent a continuous feature comprising continuous numeric values. The preprocessing that is applied to such continuous features may involve normalizing the set of data values comprised in these features using statistical techniques such as mean, standard deviation and so on.

The preprocessed primary time series dataset and the preprocessed set of features related to the primary time series dataset are then provided to a feature importance score determinator 204 within the feature selector subsystem 110 for further analysis. The feature importance score determinator 204 includes capabilities to compute feature importance scores for each feature in the set of features (e.g., 208, 212, 214) associated with the primary time series dataset. As previously described, a feature importance score is a measure of how useful a particular feature (dynamic feature and/or static feature) is at predicting a forecast value for a target variable (i.e., primary feature) of the primary time series dataset. A high feature importance score generally implies that a specific feature will have a larger effect on the model that is being used to predict the forecast value for the target variable.

In a certain implementation, the feature importance score determinator 204 may be implemented as a neural network model that computes the feature importance scores for each feature in the set of features related to the primary time series dataset. In the example depicted in FIG. 2, the neural network model represents a densely connected multi-layered neural network model composed of a set of embedding layers (216, 218, 220 and 222) and a set of dense layers (226, 228 and 230). An embedding layer refers to a type of hidden layer in the neural network model that is used to map input information from a high-dimensional space to a lower-dimensional space, allowing the network to learn more about the relationship between the inputs and to process the data more efficiently. In certain examples, the embedding layers (216, 218, 220 and 222) may be implemented using a basic linear encoder that performs the mathematical mapping of the values of a primary feature in the primary time series dataset (210) or a related feature in an additional feature time series dataset (e.g., 212 or 214) or a static metadata feature (208) into a particular data type (e.g., numerical value). For instance, an embedding layer (e.g., 218) may convert the string value of a primary feature or a related feature variable (e.g., city location) into a numerical value. In the example shown in FIG. 2, the primary time series dataset 210 and the set of features (e.g., 208, 212, 214) related to the primary time series dataset 206 are provided to various different embedding layers (216, 218, 220 and 222) in the densely connected neural network model.

The embedding layers encode (i.e., perform the mathematical mapping of) the value of a primary feature in the primary time series dataset (210) or a related feature in an additional feature time series dataset (e.g., 210 or 212) or a static metadata feature (208) into a particular data type. In certain examples, each data point in an additional feature time series dataset (212, 214) may be encoded using an embeddings layer prior to being input into a dense layer in the neural network. In certain examples, to efficiently process one or more datasets, the feature importance score determinator 204 may combine or concat (224) an embedded additional feature time series dataset (e.g., 212) with the primary time series dataset 210 and provide the concatenated time series dataset to a dense layer for further processing. The concatenation may be performed based on various factors such as the type of data values being represented by the time series datasets, the input sequence lengths of the time series datasets and so on. For example, in FIG. 1, since the primary time series dataset 210 and the past covariate time series dataset 212 comprise data values of the same type (i.e., historical values), they can be concatenated before they are input into the dense layer in the model. While the embodiment in FIG. 1, shows features (208, 212, 214) being provided to the model, in other implementations, any number (more or fewer) number of features can be provided to the model for analysis.

The encoded values of the primary time series dataset, the additional feature time series datasets and the static metadata features are then provided to a set of dense layers (226, 228, 230) in the neural network model. Each dense layer computes a feature importance score for a feature in the set of features provided to the subsystem. For instance, in the example depicted in FIG. 2, the dense layer 226 may be configured to compute a feature importance score for one or more static metadata features from the set of static metadata features provided to the feature selection subsystem 110 for analysis. For instance, if the set of static metadata features represent features such as a product type and state information that the product is sold in, the dense layer 226 computes the feature importance score for each of these static metadata features and outputs the feature importance scores for the features. Dense layer 228 may be configured to compute a feature importance score for a first related feature (dynamic feature) represented by the past covariate time series dataset (212). For instance, dense layer 228 may be configured to compute a feature importance score of the historical data points represented by the past covariate time series dataset (212). Dense layer 230 may be configured to compute a feature importance score for a second related feature represented by the future covariate time series dataset 214. For instance, dense layer 230 may be configured to compute the feature importance scores of future values of additional related features related to the primary time series data set such as a future value of holiday information, a future value of marketing promotions and so on.

The feature score computation subsystem 204 may utilize various techniques to compute feature importance scores for a set of features related to the primary time series dataset. In a certain implementation, a feature importance score may be computed as a weight value (e.g., a numerical value that is assigned by a dense layer for a particular feature. For instance, the weight value may be computed by a dense layer in the neural network model using an autocorrelation function that determines the correlation of the data values represented by a particular (related) feature to the data values represented by primary feature (i.e., primary variable) to be forecasted. A related feature that is determined to be more correlated to the primary feature is assigned a higher weight value than a related feature that is determined to be less correlated to the primary feature.

In certain examples, a dense layer (also referred to herein as a denseLasso layer) may be made up of a set of one or more dense blocks. Each dense block comprises an activation function called relu and a skip connection. The number of dense blocks in a dense layer may be determined based on the number of features that are input to the model. For instance, if three static metadata features (F1, F2, F3) are input into the feature importance score determinator for analysis, a denseLasso layer (e.g., 226 as shown in FIG. 2) pertaining the static metadata feature input 208 may comprise three dense blocks. Each skip (dense+relu) block in the denseLasso layer comprises a weight metric that determines the importance of a feature (e.g., F1, F2, F3) that is input to it. A higher weight assigned to a feature implies a higher importance is given to that feature. In certain examples, the output of a dense lasso layer may be represented as a vector of weight values for each feature (e.g., F1, F2, F3) that was input into the dense lasso layer and may be represented as (W1*F1+W2*F2+W3*F3).

The set of features along with their feature importance scores are then provided to a feature selector 206 within the feature selection subsystem 110. The feature selector 206 then selects a subset of the features 232 based on the feature importance scores and provides the selected subset of features to a feature attention score computation subsystem 110 in the time series forecasting system 108 for further analysis. In certain examples, the selection of the subset of features 232 is based on the feature importance scores that are computed for the features. For instance, in one implementation, only the features that have a non-zero weight are selected by the feature selection subsystem 110 since these features are considered more important or relevant towards the prediction of the primary target variable.

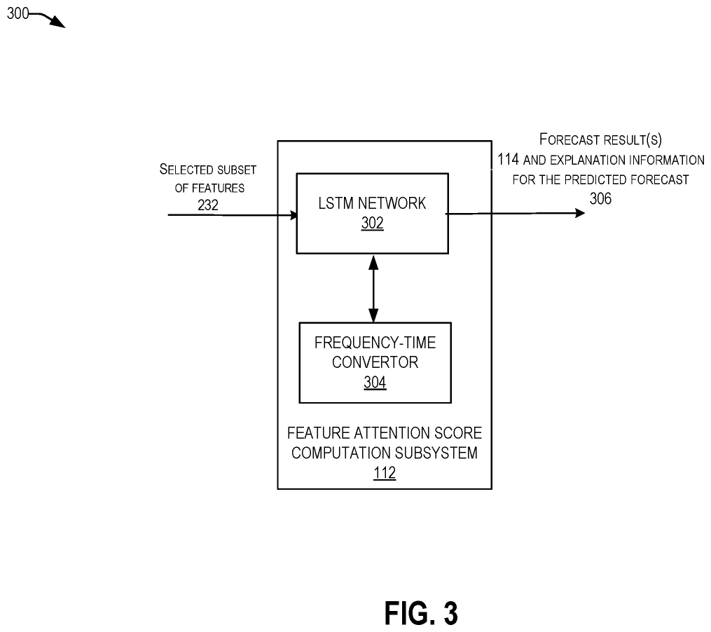

FIG. 3 depicts additional details of the processing performed by the feature attention score computation subsystem within the time series forecasting system 108 shown in FIG. 1, according to certain embodiments. As depicted in FIG. 3, the feature attention score computation subsystem 110 includes various components including a Long Short-Term Memory Network (LSTM) 302 and a frequency-time convertor 304. In a certain implementation, the feature attention score computation system 110 may be implemented using a neural network model that can be used to predict a forecast value for a target variable (i.e., primary feature) of the primary time series dataset based on the subset of features selected by the feature selection subsystem 110 as described above. The components 302 and 304 depicted in FIG. 3 may be implemented using software (e.g., code, instructions, program) executed by one or more processing units (e.g., processors, cores) of a computing system, hardware, or combinations thereof. The software may be stored on a non-transitory storage medium (e.g., on a memory device).

As previously described, the feature selection subsystem 110 provides a selected subset of features 232 to the feature attention score computation subsystem 112 for further analysis. For instance, the selected subset of features may comprise a first related feature representing a past covariate time series dataset (212) and a second related feature representing a future covariate time series dataset (214). For each selected feature, the subsystem 112 generates an encoded representation of the time series dataset represented by the selected feature. Additionally, the subsystem 112 generates an encoded representation for the primary time series dataset. The subsystem 112 then uses the encoded representations to generate the prediction for a target variable of the primary time series dataset for one or more future time steps. For example, to predict a future stock price, the subsystem 110 can analyze the stock prices over a certain time period (e.g., past one week) based on encoded representations generated for the input time steps in the primary time series dataset and the encoded representations generated for the input time steps of the selected feature time series datasets to generate a future prediction for the stock price.

In certain embodiments, the LSTM network 302 in the subsystem 112 may be configured to generate the encoded representations for the input time steps of the primary time series dataset and the input time steps of the selected feature time series datasets. The LSTM network 302 may be implemented using an encoder and a decoder. For each selected feature time series dataset, the encoder steps through the input time steps of the selected feature times series dataset and summarizes the input time steps into a context vector (state vector) to generate an encoded representation for the selected feature time series dataset. In a similar manner, the encoder generates an encoded representation for the primary time series dataset. As will be described in greater detail below, the encoded representations are then fed to a decoder in the LSTM network 302 which then starts generating predictions for the primary time series dataset for future time step(s).

The decoder in the LSTM network 302 is responsible for stepping through the output time steps while reading from the context vector. For instance, an encoded context vector for a future covariate time series dataset (e.g., 214) may represent information identifying the last time an item had a promotion. This time step contains useful information for forecasting for a target period where the future value is known (i.e., the promotion is known). The LSTM network 302 can capture the importance of this input at this time step to adequately decode the output at time step t (forecast horizon).

In certain examples, the decoding step involves computing, by the LSTM network 302, a set of query embeddings based on the current decoder state, the encoded representations of the primary time series dataset and the encoded representations of the selected feature time series datasets. The query embeddings are used to capture (determine) information identifying correlations between the encoded representations of the input time steps of the primary time series dataset and the encoded representations of the input time steps of the selected feature time series datasets. For instance, a particular time point (time step) in the historical data associated with the primary time series dataset may be determined to be correlated to a corresponding time point (time step) in a selected feature time series dataset because the corresponding time point (time step) in the selected feature time series dataset provides useful information for forecasting a future value for the primary time series dataset. As an example, the selected feature time series dataset may comprise information identifying the number of items sold for a product at different time points in the past. The number of items sold for the product at a particular past time point may represent useful information that can impact the prediction of a future value (e.g., the price of the product) of the primary time series dataset. This time point is then determined to be correlated to a corresponding time point in the historical data associated with the primary time series dataset.

Based on the determined correlations, the subsystem 112 then computes attention scores (attention weights) for one or more data points in the primary time series dataset. The more relevant data points (i.e., the data points in the primary time series dataset that are determined to be more correlated to corresponding data points in a selected feature time series dataset) are assigned higher attention weights. By assigning different attention scores to certain data points of the input sequence of each selected feature, the subsystem 112 is able to identify the relevant data points to be used for prediction of the primary dataset thereby improving the accuracy of the prediction.

As described above, the subsystem 112 described above includes capabilities to capture correlations and compute attention scores for a set of time points in the time domain. To further improve the accuracy of the attention scores computed in the time domain, in certain embodiments, the primary time series dataset and the selected feature time series datasets may be provided to a frequency-time domain convertor 304 in the feature attention score computation subsystem 110. The frequency-time domain convertor 304 enables faster correlations to take place by modeling correlations (pattern occurrences) in the frequency domain. The frequency-time domain convertor 304 utilizes frequency information pertaining to the time series datasets to learn correlations (relationships) across different time steps (current time step vs previous time step and so on) of the primary time series dataset and the selected feature time series datasets. For example, the frequency-time convertor 304 can determine the impact of a sale of a product that occurred on a particular day to a sale that occurred at a previous point in time (e.g., two days prior, 1 week prior or even a month prior). The frequency-time domain convertor 304 can also determine how correlated a future holiday is to the number of items sold for a product at a particular time point and so on.

In a certain implementation, the frequency-time domain convertor 304 may utilize a Fast Fourier Transform (FFT) to learn correlations across different time steps (current time step vs previous time step and so on) of a time series dataset in the frequency domain. As part of the processing performed by the frequency-time domain convertor 304, the input time series (e.g., a primary time series dataset or a selected feature time series dataset) is first split into a series of windows, each containing a fixed number of time steps. The frequency-time domain convertor 304 then applies a FFT algorithm to each window to compute complex-valued Fourier coefficients for each frequency component. These coefficients represent the amplitude and phase of each frequency component in the input time series. The resulting Fourier coefficients are transformed into a real-valued representation by taking the magnitude of the complex values and concatenating them with phase information. The real-valued representation is then passed through an attention mechanism (as described above) that learns to weight the importance of each frequency component based on its relevance to the task at hand. The attention scores (i.e., attention weights) are typically learned during training through backpropagation, and are based on the relationship between the input data and the target variable. Finally, the weighted frequency components are combined to produce an output, which can be used for further processing or prediction.

The frequency-time domain convertor 304 may utilize an Inverse Fast Fourier Transform (IFFT) to reconstruct the temporal information. In a certain implementation, the performance gain by performing the FFT changes to o (n log n) from N squared, so it is faster, where N is the time length. By using the FFT algorithm to compute the Fourier coefficients, the frequency-time domain convertor 304 is able to capture frequency-based patterns in the input data, such as periodic trends or other cyclical patterns. These patterns may not be apparent in the time domain, but can be more easily detected in the frequency domain.

As described above, the attention scores computed for the relevant data points in the primary time series dataset are used to generate the prediction for the target variable at a future time step. The feature attention score computation subsystem 112 then predicts an actual forecast that includes a forecast result (forecast value) predicted for a future time point for the primary time series dataset. In certain embodiments, for a forecast result (e.g., 114 as depicted in FIG. 1) predicted by the feature attention score computation subsystem 112, the feature attention score computation subsystem 112 additionally generates an explanation for the forecast, where the explanation information 306 for the forecast includes the attention scores computed for the individual time series data points in the primary time series dataset on the forecast. As previously described, the attention scores represent information indicative of the importance or impact or influence of individual time series data points (i.e., past values) in the primary time series dataset on the forecast. This enables the user to have some visibility into why the particular forecast was predicted by the model and increases the user's level of confidence in the predicted value. In certain embodiments, the explanation information 306 additionally includes the feature importance scores computed for the features selected by the feature selection subsystem 110. The forecast result along with the explanation information is provided to a requesting user.

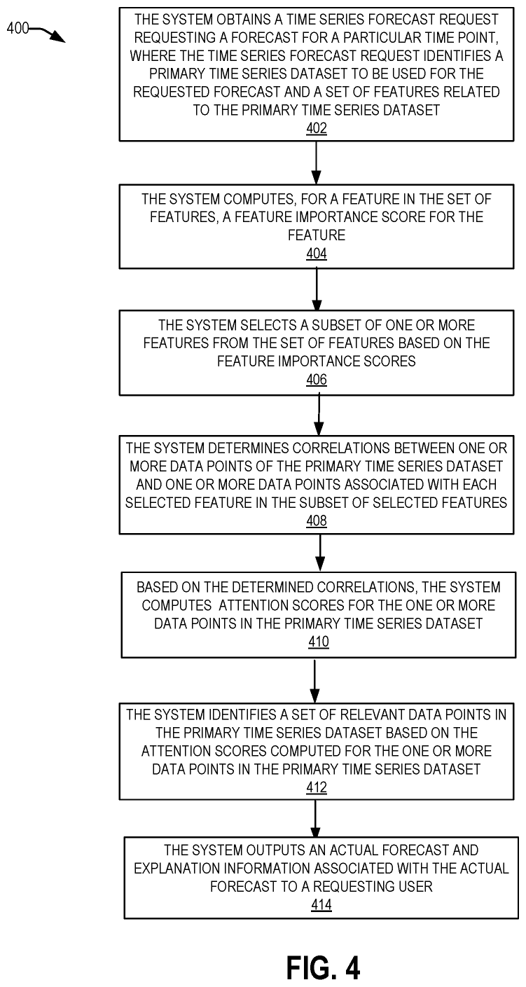

FIG. 4 depicts an example of a process 400 by which the time series forecasting system 108 shown in FIG. 1 generates a forecast for a time series dataset, according to certain embodiments. The processing depicted in FIG. 4 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 400 presented in FIG. 4 and described below is intended to be illustrative and non-limiting. Although FIG. 4 depicts the various processing steps occurring in a particular sequence or order, this is not intended to be limiting. In certain alternative embodiments, the steps may be performed in some different order or some steps may also be performed in parallel. In certain embodiments, such as in the embodiment depicted in FIG. 1, the processing depicted in FIG. 4 may be performed by the feature selection subsystem 110 and the feature attention score computation subsystem 112 in the time series forecasting system 108.

The processing depicted in FIG. 4 may be initiated when, at block 402, a time series forecast request (e.g., 104) requesting a forecast for a particular time point T is obtained for processing by the time series forecasting system 108. For example, the system 108 may receive the time series forecast request 104 from a source 102 as described in FIG. 1. As previously described, the time series forecast request 104 identifies a primary time series dataset to be used for the requested forecast. The primary time series dataset comprises a set of data points, where each data point in the time series dataset has an actual value and an associated time value less than the forecast time T. The time series forecast request is additionally associated with a set of features. As previously described, the set of features may include dynamic features that represent a characteristic (external information) related to the primary time series dataset that can change over time and/or static metadata features that remain constant over time but can provide valuable context for the items in the primary time series dataset.

At block 404, the system 108 provides the primary time series dataset and the set of features related to the primary time series dataset that are received as part of the forecast request 104 to the feature selection subsystem 110. As part of the processing performed in block 404, the feature selection subsystem 110 computes, for each feature in the set of features, a feature importance score for the feature. As previously described, a feature importance score determinator 204 within the feature selection subsystem 110 computes the feature importance scores for the features in the set of features related to the primary time series dataset. In a particular implementation, and as described in FIG. 2, the feature importance score determinator 204 is implemented as a neural network model, where a feature importance score for a feature in the set of features is computed by a specific layer (dense layer) in the model.

At block 406, the feature selection subsystem 110 selects a subset of features from the set of features, based on the feature importance scores computed in block 404 and provides the selected subset of features and their associated feature importance scores to the feature attention score computation subsystem 112 for further analysis.

At block 408, the feature attention score computation subsystem 112 determines correlations between one or more input time steps (i.e., data points) of the primary time series dataset and one or more input time steps (i.e., data points) of a feature time series dataset represented by a selected feature in the selected subset of features. As previously described, as part of the processing performed by the subsystem 112, the subsystem 112 first generates encoded representations of the input time steps of the primary time series dataset and encoded representations of the input time steps of a feature time series dataset represented by a selected feature. The feature attention score computation subsystem 112 then determines correlations between the encoded representations of the input time steps of the primary time series dataset and the encoded representations of the input time steps of the related feature time series datasets.

At block 410, the feature attention score computation subsystem 112 computes attention scores for the data points in the primary time series dataset based on the correlations determined in block 408.

At block 412, the subsystem 112 identifies the relevant data points in the primary time series dataset to be used for prediction based on the attention scores computed in block 410 for the data points in the primary time series dataset.

At block 414, the feature attention score computation subsystem 112 predicts an actual forecast for the particular time point based on the attention scores computed for the data points in the primary time series dataset. The feature attention score computation subsystem 112 then outputs the actual forecast and the explanation information associated with the forecast to a requesting user. The explanation information for the forecast includes the attention scores computed for the individual time series data points in the primary time series dataset on the forecast. As previously described, the attention scores represent information indicative of the importance or impact or influence of individual time series data points (i.e., past values) in the primary time series dataset on the forecast. This enables the user to have some visibility into why the particular forecast was predicted by the model and increases the user's level of confidence in the predicted value. The explanation information may additionally include the feature importance scores computed for the features selected by the feature selection subsystem. The forecast result along with the explanation information is provided to a requesting user of the source 102 (shown in FIG. 1).

### Example Cloud Service Infrastructure Architecture

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

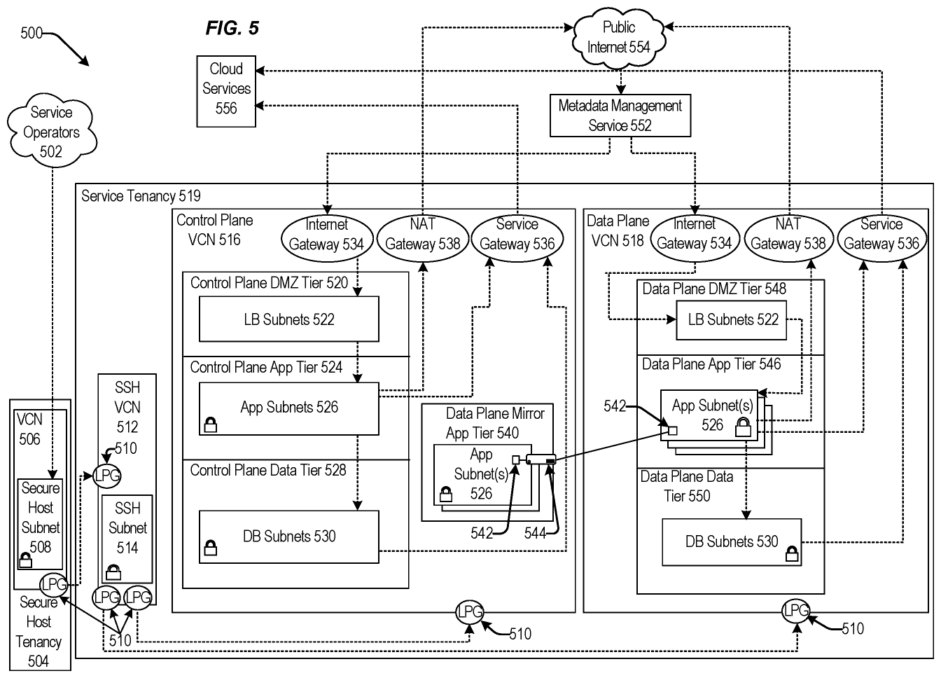

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively couple to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. But, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Metadata that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users', or other customers', resources. Also, this embodiment may allow users or customers of the system to store databases privately without needing to rely on public Internet 554, which may not have a desired level of threat prevention, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

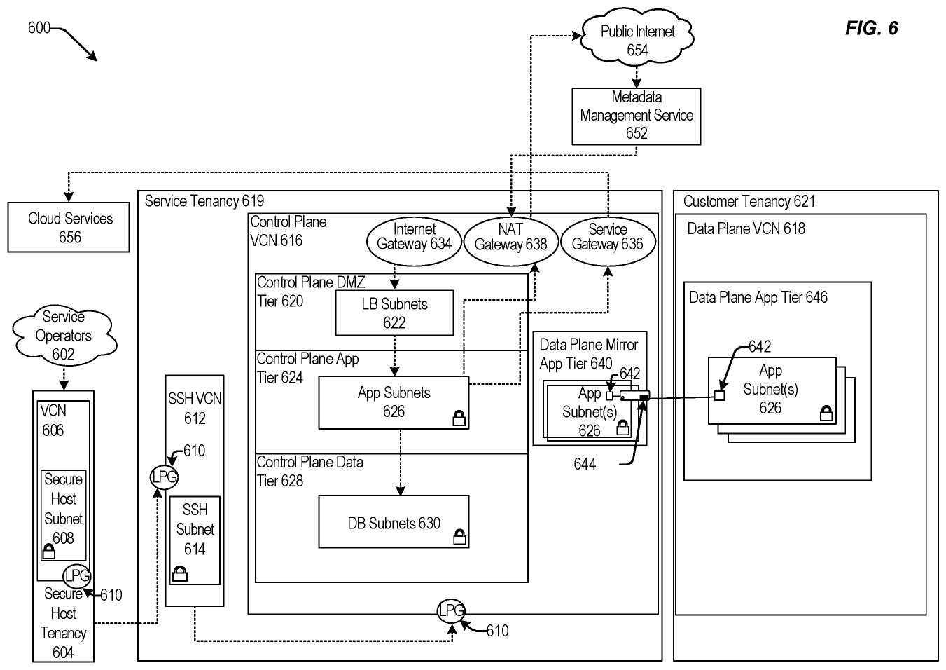

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g., the secure host tenancy 504 of FIG. 5) that can include a virtual cloud network (VCN) 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. via an LPG 510 contained in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 contained in the control plane VCN 616. The control plane VCN 616 can be contained in a service tenancy 619 (e.g., the service tenancy 519 of FIG. 5), and the data plane VCN 618 (e.g., the data plane VCN 518 of FIG. 5) can be contained in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. a control plane app tier 624 (e.g., the control plane app tier 524 of FIG. 5) that can include app subnet(s) 626 (e.g., app subnet(s) 526 of FIG. 5), a control plane data tier 628 (e.g., the control plane data tier 528 of FIG. 5) that can include database (DB) subnet(s) 630 (e.g., similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g., the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g., the service gateway 536 of FIG. 5) and a network address translation (NAT) gateway 638 (e.g., the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 contained in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g., the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 contained in the control plane VCN 616. The service gateway 636 contained in the control plane VCN 616 can be communicatively couple to cloud services 656 (e.g., cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 5,” may be located in Region 1 and in “Region 2.” If a call to Deployment 5 is made by the service gateway 636 contained in the control plane VCN 616 located in Region 1, the call may be transmitted to Deployment 5 in Region 1. In this example, the control plane VCN 616, or Deployment 5 in Region 1, may not be communicatively coupled to, or otherwise in communication with, Deployment 5 in Region 2.

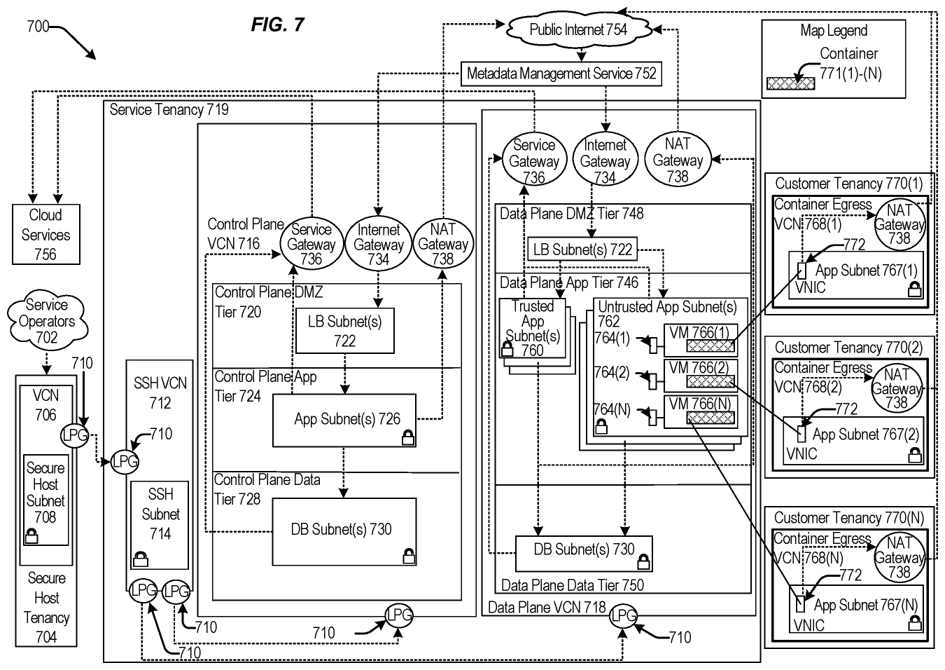

FIG. 7 is a block diagram 700 illustrating another example pattern of an IaaS architecture, according to at least one embodiment. Service operators 702 (e.g., service operators 502 of FIG. 5) can be communicatively coupled to a secure host tenancy 704 (e.g., the secure host tenancy 504 of FIG. 5) that can include a virtual cloud network (VCN) 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 contained in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 contained in the control plane VCN 716 and to a data plane VCN 718 (e.g., the data plane 518 of FIG. 5) via an LPG 710 contained in the data plane VCN 718. The control plane VCN 716 and the data plane VCN 718 can be contained in a service tenancy 719 (e.g., the service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. that can include app subnet(s) 726 (e.g., similar to app subnet(s) 526 of FIG. 5), a control plane data tier 728 (e.g., the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g., the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g., the service gateway of FIG. 5) and a network address translation (NAT) gateway 738 (e.g., the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g., public Internet 554 of FIG. 5).

The Internet gateway 734 contained in the control plane VCN 716 and contained in the data plane VCN 718 can be communicatively coupled to a metadata management service 752 (e.g., the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively couple to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

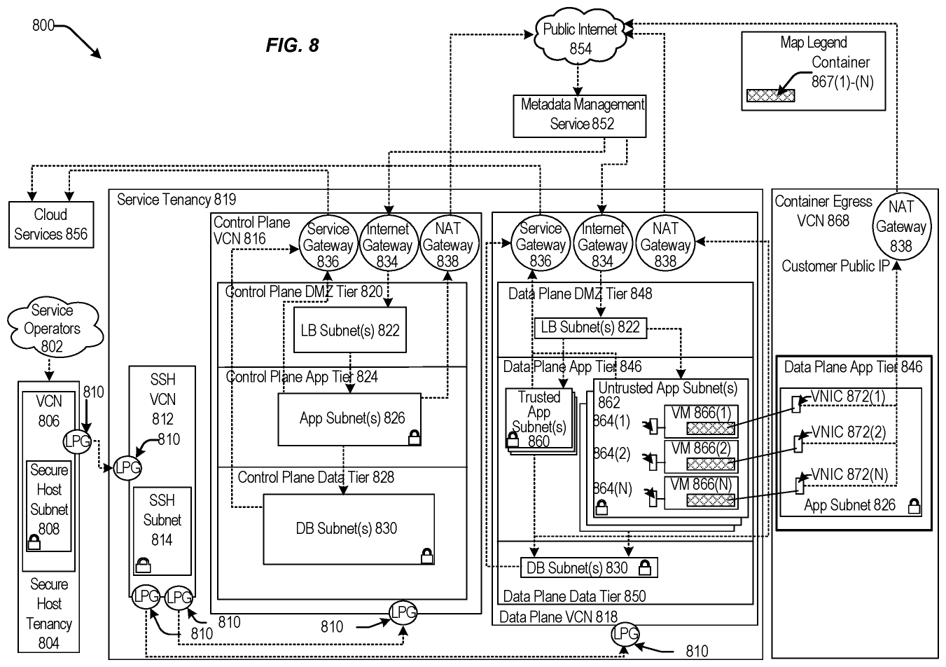

FIG. 8 is a block diagram 800 illustrating another example pattern of an IaaS architecture, according to at least one embodiment. Service operators 802 (e.g., service operators 502 of FIG. 5) can be communicatively coupled to a secure host tenancy 804 (e.g., the secure host tenancy 504 of FIG. 5) that can include a virtual cloud network (VCN) 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 contained in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 contained in the control plane VCN 816 and to a data plane VCN 818 (e.g., the data plane 518 of FIG. 5) via an LPG 810 contained in the data plane VCN 818. The control plane VCN 816 and the data plane VCN 818 can be contained in a service tenancy 819 (e.g., the service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. a control plane app tier 824 (e.g., the control plane app tier 524 of FIG. 5) that can include app subnet(s) 826 (e.g., app subnet(s) 526 of FIG. 5), a control plane data tier 828 (e.g., the control plane data tier 528 of FIG. 5) that can include DB subnet(s) 830 (e.g., DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g., the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 5) and a network address translation (NAT) gateway 838 (e.g., the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g., public Internet 554 of FIG. 5).

The Internet gateway 834 contained in the control plane VCN 816 and contained in the data plane VCN 818 can be communicatively coupled to a metadata management service 852 (e.g., the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively couple to cloud services 856.

In some examples, the pattern illustrated by the architecture of block diagram 800 of FIG. 8 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

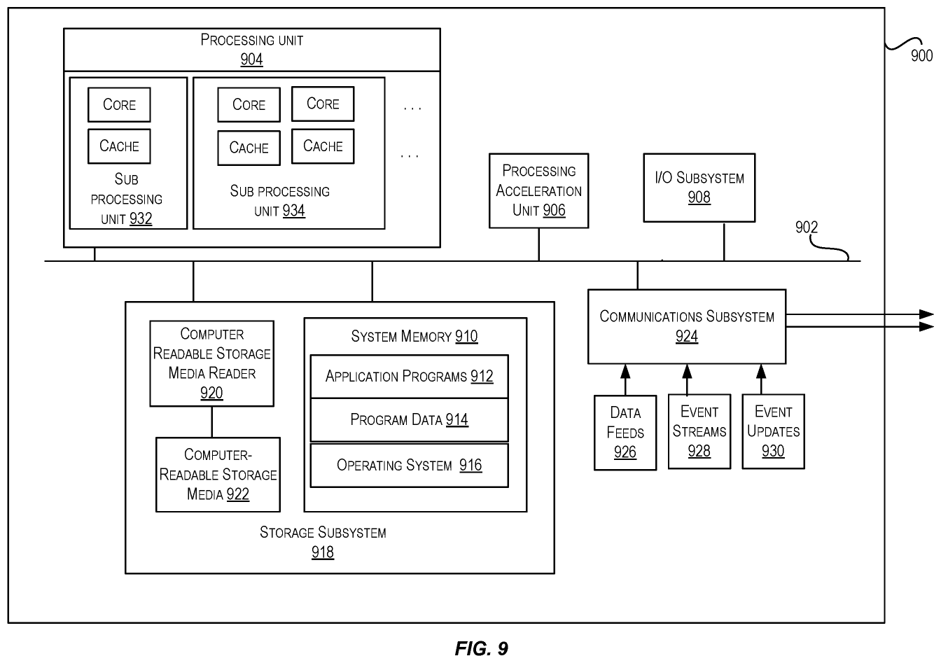

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that comprises software elements, shown as being currently located within a system memory 910. System memory 910 may store program instructions that are loadable and executable on processing unit 904, as well as data generated during the execution of these programs.

Depending on the configuration and type of computer system 900, system memory 910 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 904. In some implementations, system memory 910 may include multiple different types of memory, such as static random access memory (SRAM) or dynamic random access memory (DRAM). In some implementations, a basic input/output system (BIOS), containing the basic routines that help to transfer information between elements within computer system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916. By way of example, operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with the present disclosure.

Storage subsystem 900 may also include a computer-readable storage media reader 920 that can further be connected to computer-readable storage media 922. Together and, optionally, in combination with system memory 910, computer-readable storage media 922 may comprehensively represent remote, local, fixed, and/or removable storage devices plus storage media for temporarily and/or more permanently containing, storing, transmitting, and retrieving computer-readable information.

Computer-readable storage media 922 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 900.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
obtaining, by a computing system, a time series forecast request requesting a forecast for a particular time point, wherein the time series forecast request identifies a primary time series dataset to be used as a basis for generating the requested forecast and a set of features related to the primary time series dataset, wherein the primary time series dataset comprises multiple historical time series data points, each time series data point having a value and an associated time value;
providing, by the computing system, the primary time series dataset and the set of features to a model to be used for generating the forecast, wherein the model is trained upon or fit to the time series data points in the primary time series dataset and the set of features related to the primary time series dataset;
computing, by the computer system, using the model, a feature importance score for one or more features in the set of features;
selecting, by the computer system, using the model, a subset of features from the set of features based on the feature importance scores computed for the one or more features in the set of features;
based on the selected subset of features, determining, by the computer system, using the model, a plurality of attention scores for a plurality of data points in the primary time series dataset;
predicting, by the system, using the model, an actual forecast for the particular time point based on the plurality of attention scores determined for the plurality of data points in the primary time series dataset; and
outputting, by the system, the actual forecast and explanation information associated with the actual forecast.

2. The computer-implemented method of claim 1, wherein the set of features related to the primary time series dataset comprise a set of one or more dynamic features related to the primary time series dataset.

3. The computer-implemented method of claim 2, wherein a dynamic feature in the set of dynamic features is represented as an additional feature time series dataset related to the primary time series dataset, wherein each data point in a set of data points represented by the additional feature time series dataset comprises a value of a dynamic feature and an associated time value.

4. The method of claim 3, wherein the datapoints in the set of datapoints represented by the additional feature time series dataset represent past covariate values of the dynamic feature related to the primary time series dataset.

5. The method of claim 3, wherein the datapoints in the set of datapoints represented by the additional feature time series dataset represent a combination of past covariate values and future covariate values of the dynamic feature related to the primary time series dataset.

6. The method of claim 1, wherein the primary time series dataset is an individual time series dataset comprised in a multiple time series dataset and the primary time series dataset represents a univariate time series dataset.

7. The method of claim 1, wherein the primary time series dataset is an individual time series dataset comprised in a multiple time series dataset and the primary time series dataset represents a multivariate time series dataset.

8. The method of claim 1, wherein determining, by the computer system, the plurality of attention scores for a plurality of data points in the primary time series dataset comprises:
generating, using the model, an encoded representation of the primary time series dataset;
generating, using the model, an encoded representation of a feature time series dataset associated with a feature in the selected subset of features; and
determining, using the model, information identifying correlations between one or more data points of the encoded representation of the primary time series dataset and one or more data points of the feature time series dataset associated with the feature in the selected subset of features.

9. The method of claim 9, further comprising:
determining, using the model, the plurality of attention scores for the plurality of data points of the primary time series dataset based on the determined correlations.

10. The method of claim 1, wherein the feature importance score for a feature in the set of features is represented as a weight value, wherein the weight value represents a relevance of the feature for predicting the actual forecast for the particular time point of the primary time series dataset.

11. The method of claim 1, wherein the explanation information associated with the actual forecast comprises information identifying the plurality of attention scores determined for the plurality of data points in the primary time series dataset.

12. The method of claim 1, wherein the explanation information associated with the actual forecast comprises information identifying the feature importance scores computed for one or more features in the set of features related to the primary time series dataset.

13. The method of claim 1, wherein the plurality of attention scores represent information identifying an impact of the plurality of data points in the primary time series dataset for predicting the actual forecast for the particular time point of the primary time series dataset.

14. The method of claim 1, wherein the set of features comprise a set of one or more static metadata features related to the primary time series dataset.

15. A system comprising:
a memory; and
one or more processors configured to perform processing, the processing comprising:
obtaining a time series forecast request requesting a forecast for a particular time point, wherein the time series forecast request identifies a primary time series dataset to be used as a basis for generating the requested forecast and a set of features related to the primary time series dataset, wherein the primary time series dataset comprises multiple historical time series data points, each time series data point having a value and an associated time value;
providing the primary time series dataset and the set of features to a model to be used for generating the forecast, wherein the model is trained upon or fit to the time series data points in the primary time series dataset and the set of features related to the primary time series dataset;
computing, using the model, a feature importance score for one or more features in the set of features;
selecting, using the model, a subset of features from the set of features based on the feature importance scores computed for the one or more features in the set of features;
based on the selected subset of features, determining, using the model, a plurality of attention scores for a plurality of data points in the primary time series dataset;
predicting, using the model, an actual forecast for the particular time point based on the plurality of attention scores determined for the plurality of data points in the primary time series dataset; and
outputting, by the system, the actual forecast and explanation information associated with the actual forecast.

16. The system of claim 15, wherein the set of features related to the primary time series dataset comprise a set of one or more dynamic features related to the primary time series dataset and a set of one or more static metadata features related to the primary time series dataset.

17. The system of claim 15, wherein the explanation information associated with the actual forecast comprises information identifying the plurality of attention scores determined for the plurality of data points in the primary time series dataset.

18. A non-transitory computer-readable medium storing instructions executable by a computer system that, when executed by one or more processors of the computer system, cause the one or more processors to perform operations comprising:
obtaining a time series forecast request requesting a forecast for a particular time point, wherein the time series forecast request identifies a primary time series dataset to be used as a basis for generating the requested forecast and a set of features related to the primary time series dataset, wherein the primary time series dataset comprises multiple historical time series data points, each time series data point having a value and an associated time value;
providing the primary time series dataset and the set of features to a model to be used for generating the forecast, wherein the model is trained upon or fit to the time series data points in the primary time series dataset and the set of features related to the primary time series dataset;
computing, using the model, a feature importance score for one or more features in the set of features;
selecting, using the model, a subset of features from the set of features based on the feature importance scores computed for the one or more features in the set of features;
based on the selected subset of features, determining, using the model, a plurality of attention scores for a plurality of data points in the primary time series dataset;
predicting, using the model, an actual forecast for the particular time point based on the plurality of attention scores determined for the plurality of data points in the primary time series dataset; and
outputting the actual forecast and explanation information associated with the actual forecast.

19. The non-transitory computer-readable medium of claim 18, wherein the set of features related to the primary time series dataset comprise a set of one or more dynamic features related to the primary time series dataset and a set of one or more static metadata features related to the primary time series dataset.

20. The non-transitory computer-readable medium of claim 19, wherein a dynamic feature in the set of dynamic features is represented as an additional feature time series dataset related to the primary time series dataset, wherein each data point in a set of data points represented by the additional feature time series dataset comprises a value of a dynamic feature and an associated time value.
